(19) United States
(12) Patent Application Publication
(10) Pub. No.: US 2009/0039551 A1
(43) Pub. Date: Feb. 12, 2009

(54) SOFT CROSSLINKABLE POLYURETHANE MATERIALS

(75) Inventors: Dirk Kasper, Duessedorf (DE); Stefan Poelitz, Erkrath (DE); Andre Te Poel, Willich (DE)

Correspondence Address: LOCTITE CORPORATION, 1001 TROUT BROOK CROSSING, ROCKY HILL, CT, 06067, US

(73) Assignee: Henkel AG & Co. KGaA, Duesseldorf (DE)

(21) Appl. No.: 12/186,612

(22) Filed: Aug. 6, 2008

Related U.S. Application Data
(63) Continuation of application No. PCT/EP2007/001058, filed on Feb. 8, 2007.

(30) Foreign Application Priority Data
Mar. 20, 2006 (DE) 102006013103.7

(51) Int. Cl. B29C 45/14; C08L 67/04; C08L 71/02; C08L 33/14; C08G 71/04

(52) U.S. Cl. 264/271.1; 525/450; 525/409; 525/424; 524/599; 524/612; 528/60

(57) ABSTRACT

The invention relates to crosslinking compositions for polyurethane elastomers, made up of a polyol component containing: 30 to 80 wt % polyether diols and/or polyester diols; 10 to 40 wt % polyols comprising at least three OH groups; and to 50 wt % of a monofunctional compound that comprises an isocyanate-reactive group, and an isocyanate component containing an at least trifunctional isocyanate, such that the NCO/OH ratio is intended to be between 0.9 to 1.2. Use of the corresponding crosslinked polyurethane elastomers as molded elements is also described.

### CROSS-REFERENCE TO RELATED APPLICATIONS

This application is a continuation under 35 USC Sections 365(c) and 120 of International Application No. PCT/EP2007/001058, filed 8 Feb. 2007 and published 27 Sep. 2007 as WO 2007/107210, which claims priority from German Application No. 102006013103.7, filed 20 Mar. 2006, each of which is incorporated herein by reference in its entirety.

### FIELD OF THE INVENTION

The present invention relates to soft crosslinkable polyurethane materials that exhibit improved long-term elasticity, and to molded elements manufactured therefrom. They are made up of diols, polyols, and at least one plasticizer that comprises an NCO-reactive group and is crosslinked with an at least trifunctional isocyanate.

### DISCUSSION OF THE RELATED ART

Sealing compounds based on crosslinked or thermoplastic polyurethane materials are known. These are crosslinked materials based on polyols together with di- or polyisocyanates. Such polyurethanes are usually relatively hard and exhibit little elasticity. It is known to incorporate plasticizers into such polyurethane materials. The purpose of the plasticizers is to make the hard base polymer elastic and deformable.

US 2004/0147707 describes elastomeric polyurethane gels based on at least 75% of a reactive monoalcohol having a molecular weight greater than 1000, and 1% to 10% of an organic reactive crosslinker having a functionality greater than 3, generally a polyol, as well as a polyisocyanate compound, for crosslinking. Such polyurethane materials must be encapsulated, if applicable, because they may be highly viscous liquids rather than solids.

Also known is EP 0695786, which describes thermoplastic polyurethane elastomers. The thermoplastic polyurethane is manufactured from an organic diisocyanate reacted with mixtures of polypropylene oxide with polyesters of aliphatic dicarboxylic acids with C2 to C6 diols, and a chain-lengthening diol having a molecular weight of up to 400. Inorganic fillers are also contained in the material, as well as phenolalkylsulfonic acid esters or benzyl butyl phthalate. The corresponding uncrosslinked materials can be used as a molding compound.

WO 94/15985 is also known. It describes thermoplastic polyurethane elastomers that are manufactured on the basis of a polyisocyanate, a polypropylene oxide diol, and diethylene glycol, the molar proportion of the diethylene glycol being 2:1 to 20:1 based on the polypropylene oxide diol.

Polyurethane elastomers of this kind in accordance with the existing art can be made to be very soft. They are usable as a sealing compound to only a limited extent if they are highly viscous (because of their low crosslinking) and must be encapsulated. If the soft elastic composition is adjusted using plasticizers, a known problem is that such plasticizers can migrate out of the polyurethane material. These effects occur especially at elevated temperature, and usually result in embrittlement of the sealing compound. The latter then has little mechanical load capacity.

### BRIEF SUMMARY OF THE INVENTION

It is therefore an object of the present invention to make available a crosslinked, flexible polyurethane material, the plasticizer being chemically incorporated into the sealing compound.

The object is achieved by a composition for manufacturing crosslinked polyurethane elastomers, made up of a polyol component A) containing 30 to 80 wt % polyether diols and/or polyester diols, 10 to 40 wt % polyols comprising at least three OH groups, 1 to 50 wt % of at least one monofunctional compound that comprises a group reactive with isocyanate; a crosslinker component B) containing an at least trifunctional isocyanate, wherein the two components have an NCO/OH ratio from 0.90 to 1.2, and the monofunctional compound has a molecular weight below 2500.

The invention further relates to molded elements that can be manufactured from such soft polyurethane elastomers, and to methods for their manufacture.

### DETAILED DESCRIPTION OF CERTAIN EMBODIMENTS OF THE INVENTION

Among the difunctional compounds that are suitable for the composition according to the present invention and can be reacted with the isocyanates and are linear terminally difunctional compounds that comprise two groups reactive with NCO, such as NH, OH, SH groups. These are, in particular, polyoxyalkylene ether diols, thioether glycols, polyoxyalkylene amines, or polyester diols. These are compounds having a molecular weight from more than 400 to 20,000. “Molecular weight” is to be understood in this invention as the arithmetically averaged molecular weight (M_{N}) that can be obtained by GPC measurement.

Suitable polyether diols can be manufactured by reacting one or more alkylene oxides having 2 to 4 carbon atoms in the alkylene radical with a starter molecule that contains two active hydrogen atoms. Ethylene oxide, 1,2-propylene oxide, 1,2- or 2,3-butylene oxide are preferred as alkylene oxides. Ethylene oxide, propylene oxide, and mixtures thereof are particularly suitable. These can be mixed polymers, or polymers constructed in blocks. Further suitable polyether diols are the hydroxyl-group-containing polymerization products of tetrahydrofuran.

Corresponding reaction products having terminal thio groups or amino groups, such as aminopolyether polyols, are likewise known and commercially obtainable. OH-group-containing polymers are, however, preferred.

Suitable polyester diols can be manufactured, for example, from dicarboxylic acids having 2 to 12 carbon atoms and divalent alcohols. Suitable dicarboxylic acids are, for example aliphatic dicarboxylic acids such as oxalic acid, malonic acid, succinic acid, glutaric acid, adipic acid, suberic acid, azelaic acid, and sebacic acid, and aromatic dicarboxylic acids such as phthalic acid, isophthalic acid, and terephthalic acid. The dicarboxylic acids can be used individually or as mixtures. For manufacture of the polyester diols it may be advantageous, if applicable, to use, instead of the dicarboxylic acids, the corresponding dicarboxylic acid derivatives, such as carboxylic acid diesters having 1 to 4 carbon atoms in the alcohol radical, carboxylic acid anhydrides, or carboxylic acid chlorides. Examples of divalent alcohols are glycols having 2 to 10 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol. Depending on the desired properties, the divalent alcohols can be used individually or in a mixture with one another.

Polyester diols based on aliphatic dicarboxylic acids having 4 to 6 carbon atoms, together with diols having 2 to 6 carbon atoms, are particularly suitable.

Also suitable are esters of carbonic acid with the aforesaid diols, in particular those having 4 to 6 carbon atoms, such as 1,4-butanediol and/or 1,6-hexanediol, condensation products of ω-hydroxycarboxylic acids, for example ω-hydroxyhexanoic acid, and by preference polymerization products of lactones, for example, if applicable, substituted ω-caprolactones. Polyacetals are also suitable as a polyol component. “Polyacetals” are understood to be compounds such as those obtainable from glycols, for example diethylene glycol or hexanediol or a mixture thereof with formaldehyde. Polyacetals usable in the context of the invention can also contain acetals that are cyclic as a result of polymerization. Polyester diols of this kind are known to one skilled in the art.

A preferred embodiment of the composition contains as a diol component at least 75% polyether diols. A further embodiment of the invention uses polyester diols, or in particular polyether diols, reacted terminally with ethylene oxide.

The quantity of the diol component is to be between 30 and 80 wt % based on the quantity of all NCO-reactive constituents of component A, in particular between 40 and 70 wt %. Linear polyether diols having a molecular weight from 600 to 10,000 are particularly suitable. They can be used both individually and in the form of mixtures.

Suitable in principle as polyols that are to comprise at least three OH groups are, in principle, corresponding higher-functional polyols that are commonly known for polyester manufacture. These can be low-molecular-weight polyols having a molar weight less than 500, or those having a molecular weight greater than 500. Low-molecular-weight polyols are, for example, trimethylolethane, trimethylolpropane, glycerol, 1,2,4-butanetriol, 1,2,6-hexanetriol, pentaerythritol, or sugar-based polyols such as sorbitol.

Also suitable as preferably usable higher-molecular-weight polyols having three OH groups are, for example, liquid polyesters that can be manufactured by the condensation of di- or tricarboxylic acids such as, for example, adipic acid, sebacic acid, glutaric acid, azelaic acid, hexahydrophthalic acid, or phthalic acid with low-molecular-weight diols or portions of triols. The aforementioned diols or triols can be used. If applicable, these polyesters can be reacted with glycols at the terminal OH groups.

Particularly preferred are the polyhydroxypolyethers, known per se, having a molecular weight from 400 to 15,000, by preference 600 to 10,000, having 3 to 10 OH groups per molecule. Polyhydroxypolyethers of this kind are obtained, in a manner known per se, by alkoxylation of suitable starter molecules, for example propylene glycol, glycerol, trimethylolpropane, sorbitol, raw sugar, etc. Suitable alkoxylation agents are, in particular, propylene oxide and ethylene oxide, which can result in statistical or block copolymers.

The polyols are used in quantities from 10 to 40 wt % based on the quantity of all NCO-reactive constituents of component A, in particular from 12 to 30 wt %. These can be mixtures of different polyols. They are preferably trifunctional polyether polyols.

The diols and polyols of the composition according to the present invention comprise terminal OH groups. In order to achieve elevated reactivity, it is possible to react diols and/or polyols at the terminal group with one or more ethylene oxide groups, so that such OH groups are obtained.

The organic polyisocyanates, known per se, are suitable as at least trifunctional polyisocyanates of component B for manufacturing the composition according to the present invention. Possibilities are, for example, aliphatic, cycloaliphatic, arylaliphatic, and aromatic polyvalent isocyanates. Suitable, for example, are reaction products and trimerization products of aliphatic diisocyanates, such as ethylene diisocyanate, 1,4-tetramethylene diisocyanate, 1,6-hexamethylene diisocyanate, and 1,12-dodecane diisocyanate; cycloaliphatic diusocyanates such as cyclohexane-1,3- and -1,4-diisocyanate, 1-isocyanato-3,3,5-trimethyl-5-isocyanatomethylcyclohexane, 2,4- and 2,6-hexahydrotoluylene diisocyanate, 4,4′- and 2,4′-diisocyanatodicyclohexylmethane; aromatic diisocyanates such as 1,3- and 1,4-phenyl diisocyanate, 2,4- and 2,6-toluylene diisocyanate, 2,2′- and 2,4′- and 4,4′-diphenylmethane diisocyanate, and 1,5-naphthalene diisocyanate; aromatic polyisocyanates such as 4,4′,4″-triphenylmethane triisocyanate, 2,4,6-truisocyanatobenzene, and polyphenylpolymethylene polyisocyanate. Mixtures of different isomers or different isocyanates can also be used. Modified polyisocyanates can also be used, for example polyisocyanates comprising carbodiimide groups, polyisocyanates comprising atlophanate groups, polyisocyanates comprising isocyanurate groups, polyisocyanates comprising urethane groups, and polyisocyanates comprising ester groups. The polyisocyanates suitable according to the present invention are intended to exhibit an average functionality of at least three.

Suitable as at least trifunctional isocyanates are polyisocyanates that are produced by trimerization or oligomerization of diusocyanates, or by reaction of the aforesaid diisocyanates with low-molecular-weight polyfunctional hydroxyl- or amino-group-containing compounds such as, for example, trimethylolpropane or glycerol. Examples thereof are polyisocyanates or polyisocyanate mixtures having an allophanate structure, based on HDI, IPDI, 2,4- or 4,4-MDI, TMXDI, and/or 2,4′- or 4,4′-diisocyanatodicyclohexylmethane, HDI, MDI, TDI, or IPDI being particularly preferred as isocyanates. Suitable polyisocyanates of this kind are also commercially obtainable or can be manufactured using methods known to one skilled in the art.

Aliphatic isocyanates are particularly preferred, in particular polyisocyanates having an average functionality between 3 and 5. More highly crosslinked polyurethane elastomers are produced by the addition of portions of higher-functional isocyanates.

The polyurethane elastomer that can be manufactured according to the present invention must contain at least one monofunctional compound that comprises in the molecule only one group that is reactive with isocyanates. This constituent generally acts as an internal plasticizer. These compounds are usually liquid at 25° C.

The known H-acid groups, such as OH groups, NH groups, SH groups, COOH groups, can be used as a group reactive with isocyanates. These can be secondary or primary OH groups, primary or secondary amino groups, carboxylic acid or carboxylic acid amide groups. Primary or secondary OH groups, or secondary amino groups, are particularly preferred as an NCO-reactive group.

The monofunctional compounds suitable according to the present invention can be constructed on the basis of various polymers. It is necessary, however, for these compounds to be compatible with the polyurethane polymers. Examples of suitable monofunctional plasticizers are monofunctional polyethers based on ethylene oxide, propylene oxide, butylene oxide; polythioether compounds having a terminal SH group; polyalkylene oxide based on C2 to C4 diols, which have a terminal primary or secondary amino group; hydroxyalkylphenyl compounds that comprise a primary or secondary OH group in the alkyl group; polyalkylene-oxide-modified phenol derivatives; hydroxyfunctionalized alkyl benzyl esters, hydroxyfunctional alkylsulfonic acid esters having a primary or secondary OH group; N-alkyl-substituted benzoic acid amides or benzenesulfonamides having a primary or secondary OH group in the alkyl radical; alkylarylsulfonic esters or sulfonamides having hydroxyalkyl substituents on the sulfonic ester group or on the sulfonamide group; or polypropylene, polybutene, polyisoprene oligomers, hydrogenated polyisoprene and/or polybutadiene oligomers, vegetable or animal oils and derivatives thereof, provided these comprise exactly one, preferably terminal, OH group.

The molecular weight of the monofunctional compound is intended to be below 2500, preferably below 1000. This refers, in particular, to alkyl-substituted aromatic sulfonic acid alkyl esters or N-alkyl-substituted aromatic sulfonic acid amides, which contain a secondary or primary OH group in the alkyl substituent. The alkyl radical is intended to comprise up to 10 carbon atoms, in particular up to 6 carbon atoms. It can be linear or branched. Compounds that carry a secondary OH group on the alkyl radical are particularly preferred.

The reactive compound is intended to be used at a quantity from 1 to 50 wt % based on the quantity of all NCO-reactive constituents of component A, in particular between 5 and 35 wt %.

To manufacture the polyurethanes, components A and B, if applicable in the presence of catalysts, adjuvants, and/or additives, are caused to react in quantities such that the ratio of NCO groups to the sum of the NCO-reactive groups, in particular of the OH groups, is 0.9:1 to 1.2:1, preferably 0.95:1 to 1.1:1.

Usual polyurethane catalysts can be contained in the reaction mixture in order to accelerate the reaction between the polyhydroxyl compounds and the polyisocyanates. Basic polyurethane catalysts are suitable, for example tertiary amines such as dimethylbenzylamine, dicyclohexylmethylamine, dimethylcyclohexylamine, N,N,N′,N′-tetramethyl diaminodiethyl ether, bis(dimethylaminopropyl) urea, N-methyl or N-ethylmorpholine, dimethylpiperazine, pyridine, 1,2-dimethylimidazole, 1-azobicyclo-(3,3,0)-octane, dimethylaminoethanol, 2-(N, N-dimethylaminoethoxy)ethanol, N,N′,N″-tris(dialkylaminoalkyl)hexahydrotriazine, and in particular triethylenediamine. Also suitable, however, are metal salts such as iron(III) chloride, zinc chloride, lead octoate, and by preference tin salts, such as tin dioctoate, dibutyl tin dilaurate, tin oxides and sulfides and thiolates, such as bis(tributyl tin) oxde, dioctyl tin dioctylthiolate, dibutyl tin sulfide, dioctyl tin sulfide, bis(tributyl tin) sulfide, tin(II) octylthiolate, dibutyl tin diethylate, dihexyl tin dihexylate, dimethyl tin dineodecanoate, dibutyl tin diacetylacetonate, tin(II) phenolate, tin(II) acetylacetonate. Mixtures of tertiary amines and organic tin salts can also be used. It is useful to use 0.1 to 5 wt %, by preference 0.5 to 3 wt %, tertiary-amine-based catalyst and/or 0.01 to 0.5 wt %, by preference 0.05 to 0.25 wt %, metal salts, based on the mixture of all constituents.

Further additives can be contained in the reaction mixture in order to vary specific properties, for example color, hardness, hydrophobic properties, processing properties. These can be, for example, dyes, fillers, or pigments, such as titanium dioxide, talc, barium sulfate, calcium carbonate, carbon black, silicic acids, sheet silicates, filler fibers, and the like. The compositions according to the present invention can further contain additives such as, for example, thixotroping agents, adhesion promoters, release agents, or stabilizers. Among the stabilizers are, for example, antioxidants or light protection agents. The additives are to be selected so that they do not migrate or evaporate out of the crosslinked polyurethane elastomers. Volatile compounds such as, for example, solvents should not be contained. The additives or added substances can be contained in the composition according to the present invention at up to 10 wt %, by preference up to 5 wt %, in particular up to 2 wt %.

It is also possible to add quantities of non-functionalized plasticizers to the reaction mixture. Examples thereof are medicinal white mineral oils, naphthenic mineral oils, paraffinic hydrocarbon oils, terminally reacted polypropylene glycols and polybutylene glycols, liquid polyesters and glycerol esters, or plasticizers based on aromatic dicarboxylic acid esters. These plasticizers are intended to be compatible with the polymers. They are to exhibit a high boiling point, and are intended not to migrate out of the polyurethane elastomer. The quantity of such nonreactive plasticizers is generally below 15 wt % based on the entire composition, in particular under 5 wt %, or the compositions according to the present invention are free of such plasticizers. Solvents are preferably not to be contained in the composition according to the present invention.

The constituents for the polyurethane elastomer according to the present invention are usually present in two components. Component A encompasses those constituents that can react with NCO groups, in particular the diol component, the triol component, the monofunctional NCO-reactive component. These constituents can be mixed using known methods. This can involve a mixture that is liquid at room temperature, or one that becomes liquid at least at elevated temperatures of up to 100° C. Individual additives or all of them, for example a catalyst, pigments, stabilizers, or adhesion promoters, can be added to this mixture as applicable. Mixing of the individual components can be performed using known equipment. For example, it is possible to homogenize liquid components by intensive mixing in fast-running agitation units, e.g. dissolvers. If solid components are to be added, these can also be dispersed. If applicable, such constituents can also be ground. If this mixture is highly viscous or solid at room temperature, the viscosity can be decreased by heating. The starting materials that are used are intended, in particular, to contain no water.

The second component B is intended preferably to contain the crosslinker constituents, i.e. the polyisocyanates. These can likewise be mixed with additives, provided there is assurance that these additives do not react with the isocyanate groups. These mixtures can be solid or, preferably, liquid.

A homogeneous mixture is manufactured from the two components, in accordance with a mixing ratio predefined by the NCO/OH ratio. This can be done, for example, using the aforementioned mixing units. It is sufficient, however, if mixing is performed, directly after the metering units, using static mixers or dynamic mixing devices. This mixture is then introduced into an appropriate mold in injection molding machines known per se, and cured preferably at elevated temperature. Another procedure for manufacturing the polyurethane elastomers according to the present invention can be such that the two individual liquid components are mixed together upon injection into the mold, if the viscosity at processing temperature is sufficiently low.

In principle, the OH and NCO components are reactive with one another even at room temperature. For better processing, however, catalysts are usually added and an elevated temperature can be utilized in order to accelerate crosslinking.

The polyurethane elastomer according to the present invention is notable for high flexibility. It is permanently elastic, and that elasticity is retained even after extended storage. The covalently bonded plasticizer prevents plasticizer components from being able to migrate out of the polymer under extended load and at elevated temperatures. It is also possible to dispense with the use of health-endangering plasticizers, in particular phthalate esters. The Shore hardness of the composition according to the present invention is intended to be between 90 and 5 Shore 00, or 90 to 40 Shore 000 (measured per DIN ASTM D 2240). The hardness is preferably intended to be between 10 and 50 Shore 00. The elongation at fracture of the polyurethane elastomers according to the present invention is high. It is usually above 100%, by preference above 200%, in particular above 400% (measured per DIN 53504). Even after four weeks under load at an elevated temperature of up to 90° C., only a slight change in Shore hardness is observed.

The glass transition temperature (Tg) (determined using DSC) of the crosslinked polymers is generally below −20° C., preferably below −40° C. Because of the decreased migration of plasticizer constituents, the Tg is constant even after extended storage.

Molded parts made from the polyurethane elastomers according to the present invention are a further subject of the invention. The polyurethane elastomers according to the present invention are flexible crosslinked polymers. Molded elements can be manufactured from these polymers. These can be individual molded elements, or they are incorporated, for example, as molded elements directly onto other molded elements made of plastic or metal. The molded elements can be manufactured using known methods, for example by injection molding.

Molded elements made from the polyurethane elastomers according to the present invention, or molded elements in combination with metal molded elements or plastic molded elements, can be used, for example, as a seal. Such elastomers are, in particular, manufactured as a seal in an annular or sleeve shape, or such molded elements can be incorporated directly in other components that are to be sealed. It is possible in particular to place inserts into the injection molding mold and to join them directly, upon curing, to the polyurethane elastomer according to the present invention to yield a molded part. In a manufacturing method according to the present invention, inserts made of metal or plastic are placed as applicable into an injection molding mold. The latter is closed, and a not-yet-reacted mixture of the individual constituents is then injected into the cavity. The molded element can be crosslinked by being heated or, if applicable, also under pressure, and is then removed from the mold.

The polyurethane elastomers according to the present invention constitute a molded element. These molded elements can exhibit a tack-free surface. It is also possible, however, for them to exhibit surface tackiness. This tackiness can facilitate positioning of the molded elements and, if applicable, influence the sealing properties. By the application of external pressure, the molded element can be deformed and can adapt elastically to the contours of the parts to be sealed. The sealing action, for example against water, is retained in this context even over extended periods of time. As a result of the permanently elastic properties, a seal can be repeatedly opened and closed even after storage, while retaining its sealing properties. A further advantage of the composition according to the present invention is high thermal stability, which permits no migration of the plasticizers even after extended or cyclic temperature loading, and maintains the soft, elastic properties.

The elastic polyurethane polymers according to the present invention can also be used, for example, as a substitute material for silicone. The permanently elastic properties even under elevated temperature loading are particularly important in this context for many applications. For example, silicone materials that are subject to thermal stress can be replaced with corresponding molded elements made of the polyurethane polymer according to the present invention. Examples of such areas of application are automotive engineering or engine construction. Elastic seals made of polyurethane elastomers of this kind can also, if applicable, be manufactured in general industry. The decrease in migration or evaporation of plasticizers ensures a long-lasting performance spectrum.

### EXAMPLE 1

21.5 parts (by weight) of a trifunctional polyether polyol (molecular weight approx. 4300) having primary hydroxyl terminal groups is mixed with 50 parts of a polyether diol (molecular weight approx. 4000) based on polypropylene glycol. 0.7 parts of a commercially usual stabilizer (IRGANOX 1135, Ciba) is added, as well as 0.07 parts DBTL. The mixture is additionally mixed homogeneously with 11 parts of an N-hydroxyalkyl-substituted benzenesulfonic acid amide.

17.5 parts of a trimeric HDI reaction product (DESMODUR N 3300, Bayer) is added to this mixture (NCO:OH=0.96:1).

Immediately after manufacture, the mixture is injected into a mold and crosslinked at approx. 80° C. An elastic, slightly tacky molded element results.

Elongation at fracture is determined several times using test elements. It is above 800% (measured per DIN 53504). The hardness is measured as Shore 00 hardness. It is approx. 50 (measured per ASTM D 2240).

After storage for 30 days at 90° C., the elongation at fracture and Shore hardness are determined again. Elongation at fracture is above 900%, and Shore 00 hardness has a value of 50-55.

### EXAMPLE 2

26.6 parts (by weight) of a trifunctional polyether polyol (molecular weight approx. 4300) having primary hydroxyl terminal groups is mixed with 62.3 parts of a polyether diol (molecular weight approx. 4000) based on polypropylene glycol. 0.9 parts of a commercially usual stabilizer (IRGANOX 1135, Ciba) is added, as well as 0.08 parts DBTL. The mixture is additionally mixed homogeneously with 1 part of an N-hydroxyalkyl-substituted benzenesulfonic acid amide.

9.3 parts of a trimeric HDI reaction product (DESMODUR N 3300, Bayer) is added to this mixture (NCO:OH=1.02:1).

Immediately after manufacture, the mixture is injected into a mold and crosslinked at approx. 80° C. An elastic, slightly tacky molded element results.

Elongation at fracture is determined several times using test elements. It is above 600%. The Shore 00 hardness is 85.

After storage for 30 days at 90° C., the hardness is determined again. The Shore 00 hardness has a value of 85.

### EXAMPLE 3

19.7 parts (by weight) of a trifunctional polyether polyol (molecular weight approx. 4300) having primary hydroxyl terminal groups is mixed with 46.5 parts of a polyether diol (molecular weight approx. 4000) based on polypropylene glycol. 0.5 parts of a commercially usual stabilizer (IRGANOX 1135, Ciba) is added, as well as 0.05 parts DBTL. The mixture is additionally mixed homogeneously with 13.2 parts of an N-hydroxyalkyl-substituted benzenesulfonic acid amide.

19.5 parts of a trimeric HDI reaction product (DESMODUR N 3300, Bayer) is added to this mixture.

Immediately after manufacture, the mixture is injected into a mold and crosslinked at approx. 100° C. An elastic, slightly tacky molded element results.

Elongation at fracture is determined several times using test elements. It is above 800%. The Shore 00 hardness is 35.

### EXAMPLE 4

17.6 parts (by weight) of a trifunctional polyether polyol (molecular weight approx. 4300) having primary hydroxyl terminal groups is mixed with 41.2 parts of a polyether diol (molecular weight approx. 4000) based on polypropylene glycol. 0.5 parts of a commercially usual stabilizer (IRGANOX 1135, Ciba) is added, as well as 0.05 parts DBTL. The mixture is additionally mixed homogeneously with 17.6 parts of an N-hydroxyalkyl-substituted benzenesulfonic acid amide.

22.6 parts of a trimeric HDI reaction product (DESMODUR N 3300, Bayer) is added to this mixture.

Immediately after manufacture, the mixture is injected into a mold and crosslinked at approx. 80° C. An elastic, slightly tacky molded element results.

Elongation at fracture is above 800%. The Shore 00 hardness has a value of 25.

After storage under load (30 days/90° C.), the Shore hardness is approx. 30.

### EXAMPLE 5

22.1 parts (by weight) of a trifunctional polyether polyol (molecular weight approx. 4300) having primary hydroxyl terminal groups is mixed with 51.5 parts of a polyether diol (molecular weight approx. 4000) based on polypropylene glycol. 0.7 parts of a commercially usual stabilizer (IRGANOX 1135, Ciba) is added, as well as 0.07 parts DBTL. The mixture is additionally mixed homogeneously with 14.7 parts of a monohydroxypolypropylene glycol ether (molecular weight 1100).

10.7 parts of a trimeric HDI reaction product (DESMODUR N 3300, Bayer) is added to this mixture and homogenized.

Immediately after manufacture, the mixture is injected into a mold and crosslinked at approx. 80° C. An elastic, slightly tacky molded element results.

Elongation at fracture is above 500%. The Shore 00 hardness is approximately 65.

What is claimed is:

1. A composition for manufacturing a crosslinked polyurethane elastomer, comprising:
A) a polyol component containing:
30 to 80 wt % of one or more diols selected from the group consisting of polyether diols and polyester diols;
10 to 40 wt % of one or more polyols comprising at least three OH groups; and
1 to 50 wt % of at least one monofunctional compound that comprises a group reactive with isocyanate; and
B) a crosslinker component containing an at least trifunctional isocyanate;
wherein the the polyol component and the crosslinker component have an NCO/OH ratio from 0.90 to 1.2, and the monofunctional compound i) comprises an aromatic component and ii) has a number average molecular weight below 2500.

2. The composition according to claim 1, wherein at least one of the diols or the polyols comprising at least three OH groups contains terminal ethylene oxide units.

3. The composition according to claim 1, wherein the diols comprise at least 75 wt % polyether diols that are constructed from one or more oxide units selected from the group consisting of ethylene oxide units, propylene oxide units, and butylene oxide units.

4. The composition according to claim 1, wherein the polyol comprising at least three OH groups is a polyether polyol.

5. The composition according to claim 1, wherein the monofunctional compound has a number average molecular weight below 1000.

6. The composition according to claim 1, wherein the monofunctional compound contains an OH group.

7. The composition according to claim 6, wherein the monofunctional compound contains a sulfonamide group or a sulfonic ester group.

8. The composition according to claim 1, wherein the composition additionally comprises at least one additive selected from the group consisting of catalysts, stabilizers, and pigments.

9. The composition according to claim 1, wherein the isocyanate is a trifunctional isocyanate.

10. The composition according to claim 1, wherein the composition when cured has a Shore 00 hardness below 90.

11. The composition according to claim 1, where the monofunctional compound is selected from the group consisting of alkyl-substituted aromatic sulfonic acid alkyl esters which contain a secondary or primary OH group in the alkyl substituent, N-alkyl-substituted aromatic sulfonic acid amides which contain a secondary or primary OH group in the alkyl substituent, hydroxyfunctionalized alkyl benzyl esters, alkylarylsulfonic esters having hydroxyalkyl substituents on the sulfonic ester group, and alkylarylsulfonamides having hydroxyalkyl substitents on the sulfonamide group.

12. The composition according to claim 1, wherein the monofunctional compound is an N-hydroxyalkyl-substituted benzenesulfonic acid amide.

13. The composition according to claim 1, wherein the polyol component contains 5 to 35 weight percent monofunctional compound.

14. The composition according to claim 1, wherein the polyol comprising at least three OH groups is a polyether polyol triol.

15. The composition according to claim 1, wherein the monofunctional compound contains a secondary OH group.

16. A crosslinked polyurethane elastomer manufactured from a composition according to claim 1.

17. The crosslinked polyurethane elastomer according to claim 6, wherein the crosslinked polyurethane elastomer is in the form of a seal.

18. The crosslinked polyurethane elastomer according to claim 6, wherein the crosslinked polyurethane elastomer is molded onto an insert part.

19. A method for manufacturing a molded part, comprising the steps of:
a) placing a plastic or metal insert part into a mold having one or more cavities;
b) injecting a composition according to claim 1 into the cavities of said mold; and
c) curing the composition by heat to yield a polyurethane elastomer.

20. A method of making a crosslinked polyurethane elastomer, said method comprising reacting:
A) a polyol component containing:
30 to 80 wt % of one or more diols selected from the group consisting of polyether diols and polyester diols;
10 to 40 wt % of one or more polyols comprising at least three OH groups; and
1 to 50 wt % of at least one monofunctional compound that comprises a group reactive with isocyanate; and
B) a crosslinker component containing an at least trifunctional isocyanate;
wherein the the polyol component and the crosslinker component have an NCO/OH ratio from 0.90 to 1.2, and the monofunctional compound i) comprises an aromatic component and ii) has a number average molecular weight below 2500.
